(19) United States
(12) Patent Application Publication
(10) Pub. No.: US 2016/0332596 A1
(43) Pub. Date: Nov. 17, 2016

(54) Reversible Belt Tensioner

(71) Applicant: AUTOLIV DEVELOPMENT AB, Vargarda (SE)

(72) Inventors: Matthias Borgward, Hamburg (DE); Andreas Lucht, Horst (DE); Holger Carstensen, Husum (DE); Patrick Süllau, Henstedt-Ulzburg (DE); Philip Rings, Hamburg (DE); Andra Elsner, Sommerland (DE); Lars Rieken, Uetersen (DE); Yashwanth Singh, Karnataka (IN)

(73) Assignee: Autoliv Development AB, Vargarda (SE)

(21) Appl. No.: 15/110,578

(22) PCT Filed: Jan. 9, 2015
(86) PCT No.: PCT/EP2015/050280

§ 371 Date: Jul. 8, 2016

(30) Foreign Application Priority Data
Jan. 10, 2014 (DE) 10 2014 200 312.1

(51) Int. Cl. B60R 22/46; F16H 1/16

(52) U.S. Cl. CPC B60R 22/46; F16H 1/16; B60R 2022/4666

(57) ABSTRACT

A reversible seat belt retractor including an electric motor (2), a belt shaft (1) on which a seatbelt is windable, a drive wheel (10) disposed coaxial to the belt shaft (1), and a coupling (11) provided between the belt shaft (1) and the drive wheel (10). The electric motor (2) includes an extended drive shaft (12), via which the electric motor (2) is in direct driving connection with the drive wheel (10).

### CROSS REFERENCE TO RELATED APPLICATIONS

This application claims priority to German Patent Application No. 10 2014 200 312.1, filed on Jan. 10, 2014 and PCT/EP2015/050280, filed on Jan. 9, 2015.

### FIELD OF THE INVENTION

The invention relates to a reversible seat belt tensioner (retractor) including an electric motor and a belt shaft that is drivable in the belt-winding direction by the electric motor via a drive wheel.

### BACKGROUND

A reversible belt tensioner is known from WO 2003/099619 A2 wherein the rotational movement of the electric motor is transmitted to the belt shaft via a transmission shaft. The transmission shaft is coupled to the shaft of the electric motor via a crown-gear transmission and to the drive wheel via a worm gear transmission.

The disadvantage of this embodiment is that the arrangement of the parts with respect to one another cannot be freely chosen since the gears of the transmission each redirect the rotational movement by 90 degrees, and thus the rotational axes of the engaged rotating parts must be disposed at an angle of 90 degrees with respect to one another. Furthermore, it has been shown that the noise occurring in the crown gear transmission and the worm gear transmission during belt tensioning, in particular for premium vehicles, is no longer acceptable by automobile manufacturers.

Furthermore, a solution is known from DE 10 2008 048 339 A1 wherein the transmission shaft is connected to the drive wheel and/or the electric motor via a helical gear transmission. The use of a helical gear transmission offers the advantage that the rotational axes of the engaged parts can also be disposed at angles other than 90 degrees with respect to each other. The parts can thereby be disposed at any angle with respect to one another, so that the arrangement can occur in terms of a compact embodiment and use of the available free space. Since the parts in the helical gear transmission only come to abutment at a point, noise generation is also substantially reduced. Helical gear transmissions in general are distinguished in that helical gears having different helix angles, but the same pitch and the same engagement angle, are paired. Due to different helix angles, the wheel axes can intersect at any angle. Furthermore, by the choice of the helix angle a helical transmission has the inherent advantages that the helical gears offer, in addition to the diameter ratio, an additional possibility to change the translation ratio. In addition, the helical gears of the helical gear transmission can be axially displaced without the helical gears thereby coming out of engagement. The requirements for the manufacturing tolerances are thereby significantly reduced so that the complexity and the costs of achieving the required manufacturing tolerances are significantly reduced.

### SUMMARY

The object of the invention is to provide a cost-effective, reversible belt tensioner (retractor) that should have as simple as possible a constructive design.

To achieve the object, according to the invention a reversible belt tensioner having the features described herein.

According to a feature of the invention it is proposed that the electric motor includes an extended drive shaft, via which the electric motor is directly in driving connection to the drive wheel. Due to the direct driving of the drive wheel via the extended drive shaft, it is possible to omit the second redirecting transmission that was previously required for redirecting the rotational movement of the drive shaft to the provided transmission shaft. The constructive design of the belt tensioner can thereby be significantly simplified. Furthermore, due to the omission of the redirecting transmission, the noise generation during the activating of the belt tensioner can be reduced. In addition, the bearing assembly can be significantly simplified since in contrast to the transmission shaft previously used, the drive shaft does not require its own bearing assembly in the transmission housing, provided that the bearing assembly of the drive shaft in the electric motor is sufficiently dimensioned to support the occurring axial forces.

It is further proposed that the electric motor is disposed and arranged such that the longitudinal axis of the drive shaft and the rotational axis of the drive wheel are oriented at an angle of 90 degrees with respect to each other, and the drive shaft is coupled to the drive wheel via a 90-degree redirecting transmission. Due to the proposed arrangement of the electric motor and the orientation of the drive shaft thereby achieved, a particularly simple constructive design of the belt tensioner can be realized, whereby the manufacturing costs are reduced and the functional integrity or the life expectancy of the belt tensioner can be increased. Using the proposed solution,the rotational movement of the electric motor can be redirected in a single redirecting transmission, whereby the losses compared to the solution known in the prior art can be reduced.

It is further proposed in accordance with the present invention that the electric motor is disposed and oriented such that the longitudinal axis of the drive shaft extends inside a disc that is defined by an imaginary spatial extension radially outward of the drive wheel with respect to its rotational axis. Using the proposed solution, the transmission unit can be embodied in a very flatly constructed manner with the electric motor. Here it is of particular advantage that using the proposed arrangement the drive shaft can be disposed in a housing without having to be widened for this purpose.

A particularly compact construction of the belt tensioner can be achieved if the electric motor is disposed and oriented such that the longitudinal axis of the drive shaft is disposed in the central plane of the drive wheel, which central plane is disposed perpendicular to the rotational axis of the drive wheel.

It is further proposed that the electric motor and the drive wheel are preinstalled as a subassembly in a common transmission housing. Using the proposed solution, the assembly process of the belt tensioner can be simplified provided that the electric motor is first preinstalled with the drive wheel in the common transmission housing, and then the preassembled subassembly is installed on the belt tensioner in a second step. The electric motor can thereby be installed together with the drive wheel in the transmission housing by a third party, for example by a subcontractor.

Further, in accordance with the present invention, a particular compact construction with a simultaneous high functional integrity can be realized by a worm gear being provided on the drive shaft, which worm gear engages in an external gearing of the drive wheel, and the outer diameter of the worm gear is less than or equal to the width of the external gearing of the drive wheel. Using the proposed solution, a transmission unit can be realized whose width is at least not increased by the redirecting transmission or the worm gear. Rather, the worm gear can rotate freely in a free space adjacent to the drive wheel, the width of which free space need not be enlarged in the transition from the drive wheel. The worm gear is thereby protected towards the exterior by the housing comprising the drive wheel.

Here the rotational movement of the electric motor can be transmitted particularly simply and efficiently to the drive wheel and the belt shaft if the rotational movement of the drive shaft in a worm gear transmission is transmitted to the drive wheel with a single transmission step in a translation ratio I of 45<I<65.

It is further proposed that the reversible belt tensioner includes a transmission housing attached such that it is fixed with respect to the belt tensioner, and the electric motor is attached in the transmission housing. Using the proposed solution, the electric motor no longer requires its own attachment to the frame of the belt tensioner, whereby both the installation process and the constructive design of the belt tensioner can be simplified.

It is further proposed that a control unit for controlling the reversible belt tensioner is provided in the transmission housing. The transmission housing thus forms a constructive unit with all components required for driving the belt shaft, from the controlling to the transmission of the rotational movement. Thus a conventional belt tensioner can be identically built with the smallest possible constructive adaptations, with and without a reversible belt tensioner function as desired.

### BRIEF DESCRIPTION OF THE DRAWINGS

The invention is explained in more detail below with reference to preferred exemplary embodiments.

FIGS. 1 and 2 show a reversible belt tensioner according to the prior art; and

FIGS. 3 to 5 show a transmission unit of an inventive belt tensioner in different views.

### DETAILED DESCRIPTION

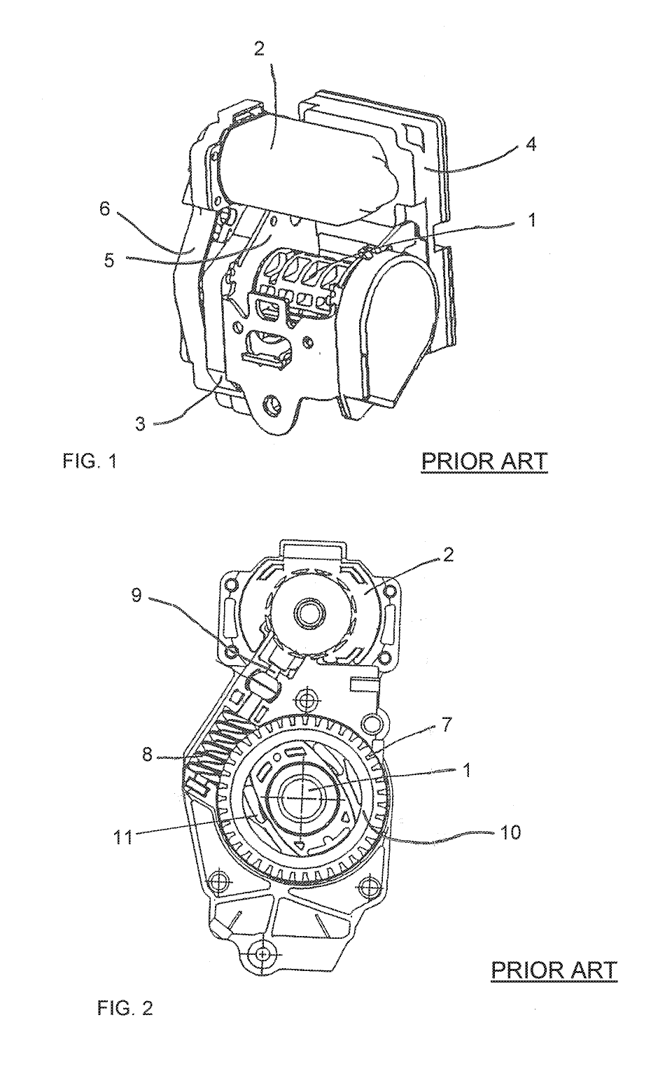

In FIG. 1 and FIG. 2 a reversible belt tensioner (retractor) known from WO 2003/099619 A2 can be seen, which includes a belt shaft 1 and an electric motor 2 driving the belt shaft 1 in the winding direction during the reversible tensioning. On the side of the reversible belt tensioner an electronic control unit 4 (ECU) is disposed that controls the electric motor 2. Furthermore, on the end side of the belt tensioner housing 5 a transmission housing 3 including a corresponding cover 6 is provided.

In FIG. 2 the known reversible belt tensioner (retractor) can be seen from the transmission side, but without cover 6. Between the belt shaft 1 and the electric motor 2 a transmission shaft 9 can be seen that engages in a gearing 7 of a drive wheel 10 via a worm gear 8. The connection between the electric motor 2 and the drive shaft 9 is realized here by a crown gear transmission (not depicted). The drive wheel 10 is furthermore connectable to the belt shaft 1 via a coupling 11 so that during the belt tensioning, the rotational movement of the electric motor is finally transmitted to the belt shaft 1 via the coupling 11 by rotating of the transmission shaft 9 and driving of the drive wheel 10. In this design, the rotational movement of the electric motor 2 is transmitted via two redirection transmissions and the drive shaft 9, wherein the rotational axes of the belt shaft 1 and of the electric motor 2 are oriented parallel to each other.

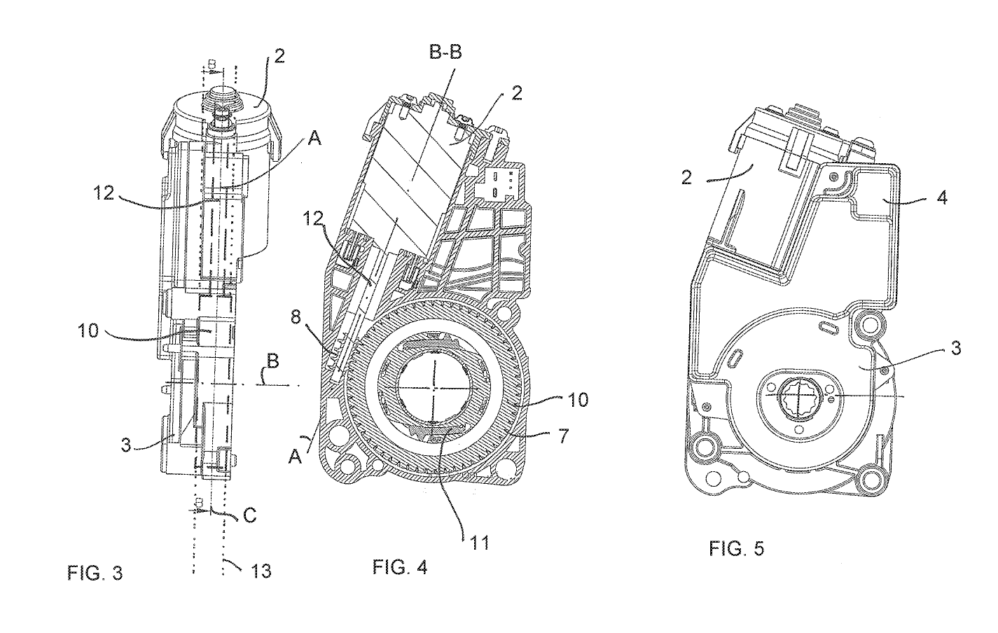

In FIG. 3 to FIG. 5 the transmission unit of a reversible belt tensioner (not retractor) can be seen in accordance with the present invention, wherein functionally identical parts are provided with the reference numbers that were already used in the description of the prior art reversible belt tensioner in FIG. 1 and FIG. 2.

In this further development, the electric motor 2 is integrated in the transmission housing 3, which is attached as a preassembled subassembly to the frame of the reversible belt tensioner (retractor) wherein the belt shaft 1 is rotatably supported. The electric motor 2 is supported during activation on the transmission housing 3, which in turn is supported on the motor vehicle structure via the frame of the belt tensioner. The electric motor 2 includes a drive shaft 12 that extends from the electric motor 2. The drive shaft 12 is provided on its end with a worm gear 8, which in turn engages in the gearing 7 of the drive shaft 10. The electric motor 2 thus drives the drive wheel 10, and, via the coupling 11, also the belt shaft 1 directly via the drive shaft 12. Here the coupling 11 is illustrated as a friction-actuated, automatically switching coupling that automatically couples the drive wheel 10 to the belt shaft 1 in the event of a driving force applied by the electric motor 2. Using the proposed solution, a very cost-effectively manufactured belt tensioner having a very simple design can be realized. Together with the gearing 7 of the drive wheel 10, the worm gear 8 forms a single, one-step 90-degree redirection engagement, using which the rotational movement of the electric motor 2 is transmitted to the drive wheel 10. The efficiency of the belt tensioner can thereby be significantly improved compared to the solution used in the prior art, and the noise generation can be reduced. The rotational movement of the drive shaft 12 here is preferably transmitted to the drive wheel 10 in a translation ratio I of 45 <I <65, preferably of I =56, in a slower rotational movement, wherein the rotational speed of the electric motor 2 is 16,000 rpm, and the drive wheel 10 is driven to a rotational movement having a rotational speed of 270 to 290 rpm. Here the worm gear 8 has a diameter of approx. 8.5 mm to 8.7 mm, with a pitch angle of the tooth flanks of 8 to 9 degrees, while the drive wheel 10 has an outer diameter of 61.8 mm to 62.0 mm with a pitch angle of the tooth flanks of 8 to 9 degrees.

The electric motor 2 including the extended drive shaft 12 is oriented and disposed such that the longitudinal axis A of the drive shaft 12 is oriented perpendicular to the rotational axis B of the drive wheel 10 and extends in the central plane C thereof, which central plane C is oriented perpendicular to the rotational axis B of the drive wheel 10. The drive shaft 12 is thereby simultaneously disposed inside a disc 13 bounded by the dotted lines, which disc 13 is defined by the radially outwardly imagined extension of the drive wheel 10 perpendicular to its rotational axisB. The drive shaft 12 thereby does not laterally protrude past the drive wheel 10, and a very flat transmission housing 3 can be realized. Furthermore, the diameter of the worm gear 8 is smaller than the width of the gearing 7 of the drive wheel 10. Overall, a very compact and flatly constructed transmission housing 3 can be realized by the dimensioning of the worm gear 8 and by the orientation and arrangement of the electric motor 2.

Furthermore, the control unit 4 contains the transmission housing 3, so that the former is also attached to the belt tensioner via the transmission housing 3 and requires no separate attachment of its own. The transmission housing 3 thus includes all components required for realizing the reversible belt-tensioning function, from the controlling function via the drive device to the drive wheel 10, including the coupling 11, so that a conventional belt tensioner can thereby be equipped with a reversible belt tensioning function with simple measures without additional constructive expense. The control unit 4 is preferably adapted in its external form to a corresponding opening in the transmission housing, or vice versa. The circuit board of the control unit 4 can preferably be configured L-shaped or S-shaped, so that it can be mass produced with very efficient use of the surface area of standard panels and can be cut out therefrom.

While the above description constitutes the preferred embodiment of the present invention, it will be appreciated that the invention is susceptible to modification, variation and change without departing from the proper scope and fair meaning of the accompanying claims.

1. A reversible seat belt retractor comprising,
an electric motor,
a belt shaft, on which a seatbelt is windable,
a drive wheel disposed coaxial to the belt shaft
a coupling provided between the belt shaft and the drive wheel,
the electric motor includes an extended drive shaft, via which the electric motor is in direct driving connection with the drive wheel.

2. A reversible seat belt retractor according to claim 1, further comprising,
the electric motor is disposed and oriented such that the longitudinal axis of the drive shaft and the rotational axis of the drive wheel are oriented with respect to each other at an angle of 90 degrees, and
the drive shaft is coupled to the drive wheel via a 90-degree redirection engagement.

3. A reversible seat belt retractor according to claim 1 further comprising,
the electric motor is disposed and oriented such that the longitudinal axis of the drive shaft extends inside a disc, which is defined by an imaginary spatial extension of the drive wheel radially outward with respect to the rotational axis of the drive wheel.

4. A reversible seat belt retractor according to claim 1 further comprising,
the electric motor is disposed and oriented such that the longitudinal axis of the drive shaft is disposed in the central plane of the drive wheel, which central plane is disposed perpendicular to the rotational axis of the drive wheel.

5. A reversible seat belt retractor according to claim 1 further comprising,
the electric motor and the drive wheel are preinstalled as a subassembly in a common transmission housing.

6. A reversible seat belt retractor claim 1 further comprising,
a worm gear is provided on the drive shaft, and the worm gear engages in a gearing of the drive wheel, and
the diameter of the worm gear is less than or equal to the width of the drive wheel.

7. A reversible seat belt retractor according to claim 1 further comprising,
the rotational movement of the drive shaft in a worm gear transmission is transmitted to the drive wheel with a single transmission step by a worm geat rotated by the drive shaft and meshing with a gearing of the drive wheel with a ratio (I) of 45<I<65.

8. A reversible seat belt retractor according to claim 1 further comprising,
the reversible belt retractor includes a transmission housing attached with respect to the belt tensioner, and
the electric motor is attached to the transmission housing.

9. A reversible seat belt retractor according to claim 8, further comprising
a control unit for controlling the reversible belt retractor is provided in the transmission housing.

10. A reversible seat belt retractor according to claim 8 wherein the transmission housing supports an extending end of the drive shaft.
